(19) United States
(12) Patent Application Publication
(10) Pub. No.: US 2006/0157564 A1
(43) Pub. Date: Jul. 20, 2006

(54) Shopping list manager and marketing data collector

(76) Inventor: Carl Henry Schulte, Oneonta, NY (US)

Correspondence Address: Carl H. Schulte, 14472 Huntcliff Pky, Orlando, FL, 32824, US

(21) Appl. No.: 11/037,978

(22) Filed: Jan. 18, 2005

(51) Int. Cl. G06K 15/00

(52) U.S. Cl. 235/383

(57) ABSTRACT

The present invention concerns a device that incorporates a scanner, a display system, a key pad and an output device for managing a shopping list of consumer goods to be purchased in the near future by the user. The device includes a microprocessor having a memory that stores a list of consumer goods and information about those consumer goods. The device can receive additional product information from the user and/or the manufacturer of the device, a store, supplemental input devices or other sources. The device maintains a list of the consumer goods and will provide a display or print out of that list along with the store, price, category and aisle where the goods can be found and at what price. This enables the user to determine which store in their area offers the best price on each item, sorting the shopping list into one or more lists which are store specific and saving the consumer hundreds to thousands of dollars per year and significant comparison shopping time as a result. In exchange for providing data to the user on the products, the store obtains pending purchase data provided by cumulative users of the device. This will allow the store to project demand, receive early warning on items which would be out of stock based on this ‘imminent demand’ as compared to the store's current inventory and delivery schedule. Thus, the store can correct the inventory deficiency prior to the cumulative users coming to the store with their shopping lists. This benefits the buyer in that their desired items are less likely to be out of stock and benefits the retailer since they will not miss a sale due to out of stock items.

### BACKGROUND OF INVENTION

1. Field of the Invention

The present invention relates to a device for collecting and maintaining data on consumable goods in a list. More particularly, the present invention relates to a device for collecting, storing and outputting a list of consumer goods, (presumably which the user intends to purchase upon outputting said list). Additionally, said list can be cross referenced with the databases of assorted stores in an effort to assemble a list based on price, store location, availability and other potential criteria. Note: the present invention does not track inventories of the consumer goods.

2. Description of the Prior Art

In a hectic world, it is becoming more difficult for households to establish a cognizant list of consumable goods needed by the individual household members. Additionally, many consumers do not want to maintain intensive databases and inventory control systems in their personal homes. A simple, intuitive device which does the listing, sorting and comparison shopping for the residential consumer, or small business purchasing manager, is what is needed.

U.S. Pat. No. 6,616,049 discloses a system which creates a shopping list for the purpose of generating sales incentives (i.e. coupons) for items on the list. This may be less than appealing since many consumers may not wish to be marketed to in this fashion. Additionally, this system does not comparison shop or sort shopping list data.

U.S. Pat. No. 6,386,450 discloses a system which organizes a consumer's movement through a store providing distance and direction to items in that store and the list is maintained on a data card. While useful, this hand held device will be less convenient than a list of goods presorted in the order they appear within the store.

Additionally, people carry many hand held devices as it is and using this one and using a cell phone at the same time, for example, may be cumbersome.

U.S. Pat. No. 6,131,812 discloses a system which monitors the inventory of consumer goods by means of scanning, quantity entry and the use of a scale. It additionally provides medical interaction alerts. However, this system requires significant user input; has the potential of user error, the potential of health affecting risks where medications are concerned; and requires users to maintain and manage a significant database of household inventories, weights, calories, preferences and other data to achieve full functionality.

U.S. Pat. No. 5,870,716 discloses a system which tracks user purchasing trends via store input and generates a shopping list based on an estimated consumption interval, However people's tastes change over time and most may like a bit more control over their shopping list. Additionally, vacations, holidays, guests, etc. may throw off the system as consumption changes due to these variables.

U.S. Pat. No. 5,884,281 discloses a system which creates an electronic shopping list from stored or manual data specifically without a scanner. The list may be transmitted for fulfillment, but there is no comparison shopping feature or multiple user options.

U.S. Pat. Nos. 5,335,509 and 5,487,276 disclose systems which monitor the expiration dates of various products and provide an alert when a product is close to its expiration date. However, these systems require significant user input; and require users to maintain and manage a significant database of household inventories and they do not comparison shop.

None of the above inventions and patents, taken either singly, or in combination, is seen to describe the present invention as claimed.

Accordingly, there is a need for a device which can efficiently and simply maintain a record of consumable goods which need to be purchased in the near future, without the complexities of micro-managing a home inventory system, recording weights and other units of measure, medical interactions, quantities, consumption rates and other data. Additionally, this system should be able to advise the retail store of imminent demand so that the retailer can ensure sufficient inventory to supply the imminent demand of the cumulative users' shopping lists.

### SUMMARY OF THE INVENTION

The present invention relates to a hand held, free standing or mountable device, which can be surface mounted or inset in various locations, incorporating a scanner, display system, output device and potentially, supplemental input devices. The system includes a microprocessor with memory means for storing information about consumer goods. Various means are associated with the microprocessor for inputting information regarding the consumer goods. The system computes and stores a shopping list, store name, retail price and location information. The information can be displayed in visual or audible form. A printer, modem or other communications device may also be provided for outputting the information.

### BRIEF DESCRIPTION OF THE DRAWINGS

FIG. 1 is a partial isometric view of the present invention surface mounted on a wall.

FIG. 2 is a partial isometric view of the present invention shown in three potential locations: free standing (on a counter top) surface mounted under a kitchen cabinet and surface mounted on the side of a kitchen cabinet.

FIG. 3 is a partial isometric view of the present invention inset in an appliance door (refrigerator or freezer in this illustration).

FIG. 4 is a partial isometric view of the present invention surface mounted as part of a wall telephone.

FIG. 5 is a logistical display of a minimal combination of potential internal components.

FIG. 6 is a logistical display of a significant combination of potential internal components.

FIG. 7 is a front elevation view of a typical input/output (I/O) center of the present invention.

FIG. 8 shows an example of printed output of a typical shopping list.

FIG. 9 is a logistical display of a supplemental input device.

### DETAILED DESCRIPTION OF THE INVENTION

The preferred embodiment will be described with reference to the drawing figures where like numerals represent like elements or like associated devices throughout.

List of potential elements:
1. The device. The present invention. The summation of several or all of the other elements herein for the express purpose herein defined.
2. The supplemental input device. A secondary or supplemental device which attaches to the device 1 having fewer features than the device 1. The summation of several or all of the other elements herein for the express purpose herein defined.
3. The shopping list. A list of consumer goods due for purchase in a digital form or as a hard copy on paper.
4. The copyright notification.
10. The processor assembly.
11. The microprocessor.
20. The input/output center.
21. The visual display.
22. The key pad.
23. The decals.
24. Brail signage.
30. The scanner.
31. The light pen.
32. The cord.
33. The holding clip.
40. The printer.
50. The modem.
51. The modem port.
52. The input/output port.
60. The speaker.
61. The microphone.
70. The wireless network transmitter.
71. The satellite link.
72. The cellular receiver.
73. The inferred data transmitter/receiver.
74. The remote control.
80. The power source.
81. The electrical plug.
82. The battery backup.

Referenced Associated Devices
90. Appliance surface (Typical).
   The surface, door, face, side, top or bottom of a refrigerator, freezer, stove, range, dishwasher, microwave, cooling drawer, warming drawer or other household appliance. [not an actual part of the present invention, but a typical mounting surface for the device 1 or device 2.]
91. Casework (Typical).
   Any cabinets typically found in a kitchen, pantry, bathroom, garage, house or office. [not an actual part of the present invention, but a typical mounting surface for the device 1 or device 2.]
92. Wall (Typical).
   [Not an actual part of the present invention, but a typical mounting surface for the device 1 or device 2.]
93. Telephone (Typical).
   [Not an actual part of the present invention, but a typical mounting location for the device 1 or device 2.]

### DETAILED DESCRIPTION

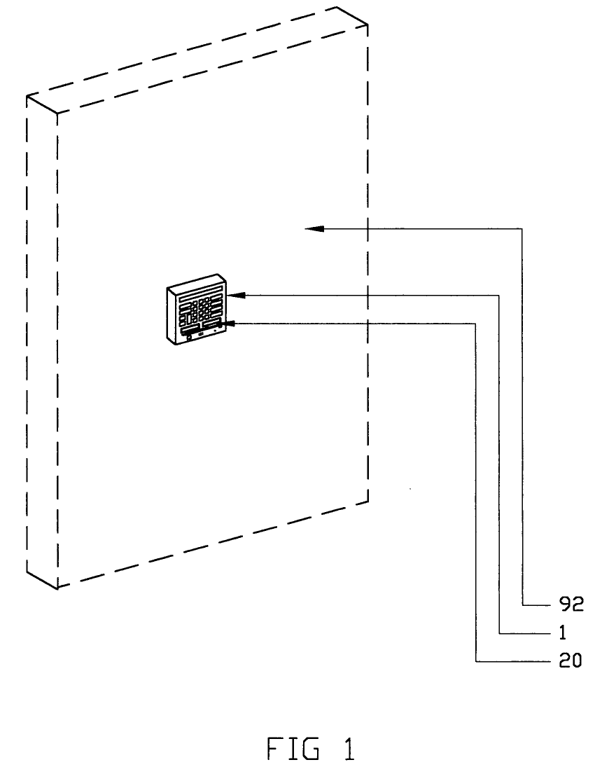

FIG. 1 shows the device 1 surface mounted on a typical wall 92.

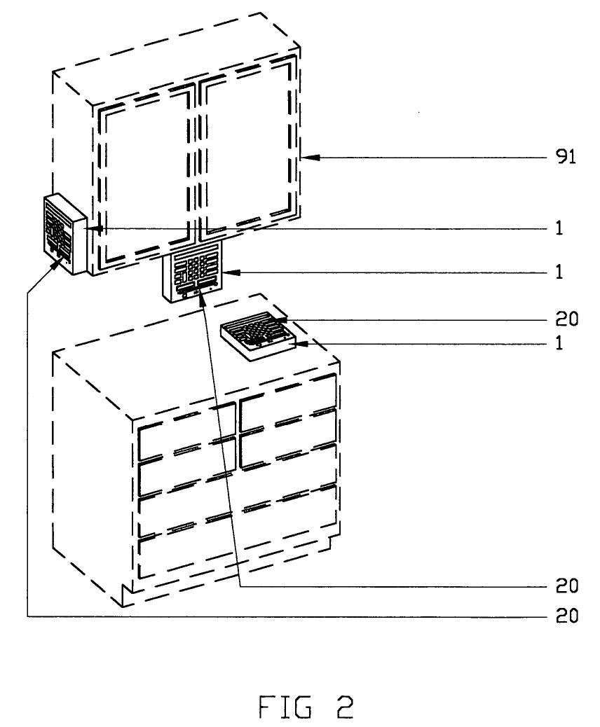

FIG. 2 shows the device 1 surface mounted under typical casework 91, and a second device 1 surface mounted on the side of the casework 91 and a third device 1 sitting free standing on top of the countertop. An assortment of fastening methods could be used to secure the device 1.

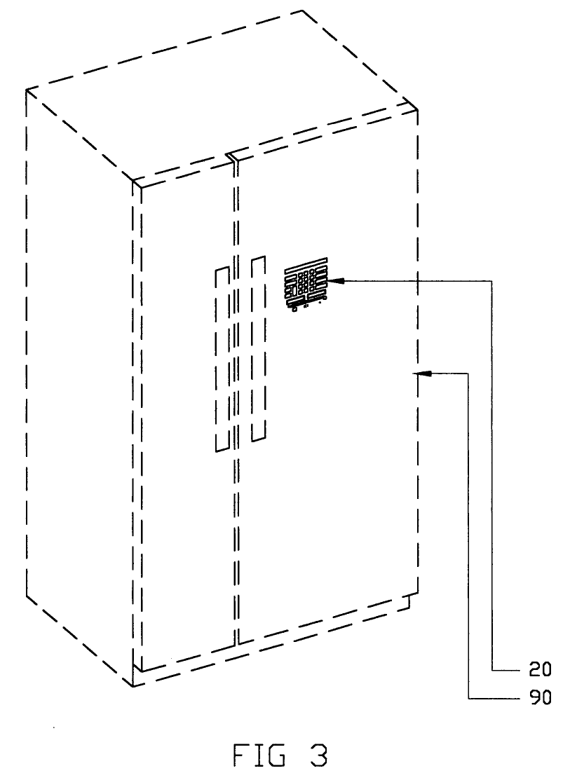

FIG. 3 shows the device 1 inset in the door of a typical appliance 90.

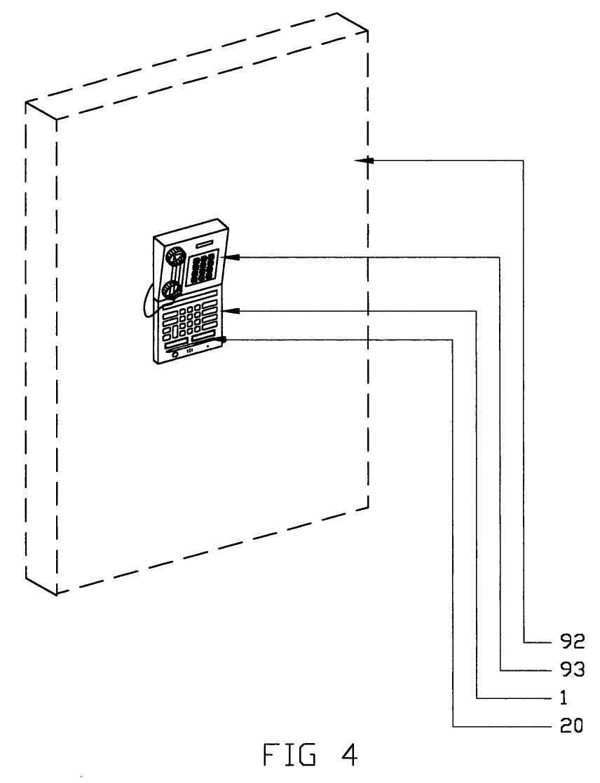

FIG. 4 shows the device 1 surface mounted on a typical wall 92 as part of a typical telephone 93. The device 1 may be connected to an existing telephone 93 or be part of the internal components of a newly manufactured combination device 1 and telephone 93.

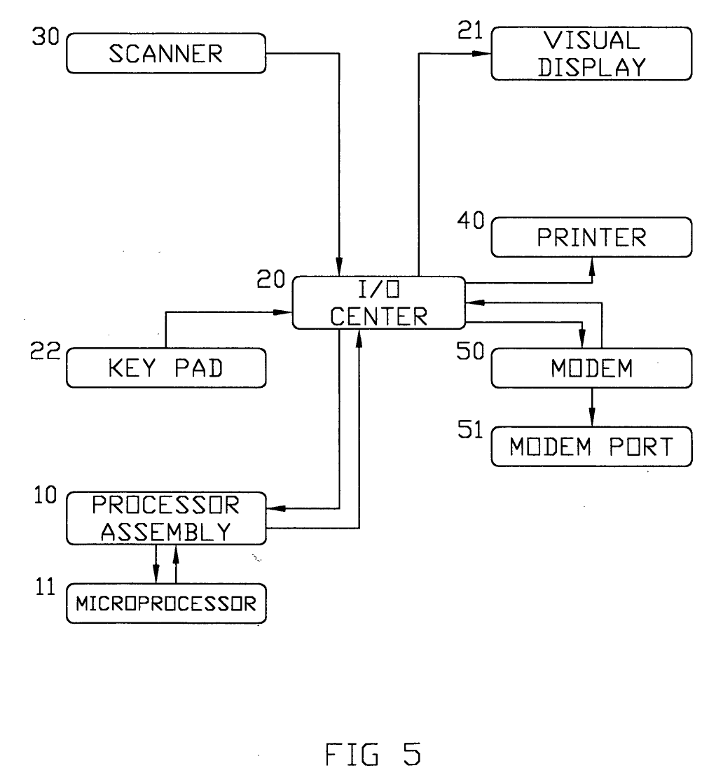

FIG. 5 shows a logistical display of a device 1 with a minimal number of elements included.

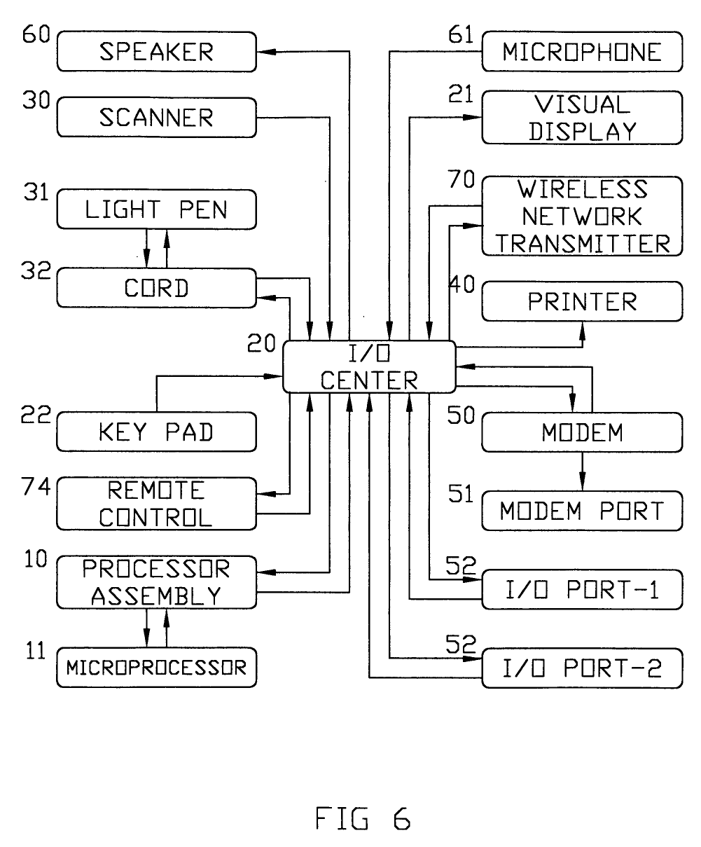

FIG. 6 shows a logistical display of a device 1 with a large number of elements included.

Note: a manufactured device 1 may consist of a configuration somewhere between that of the configuration shown in FIG. 5 and that of the configuration shown in FIG. 6. Additionally, some other elements may be substituted for the elements shown in FIG. 5 or FIG. 6 for example: a keyboard might be substituted for the key pad 22.

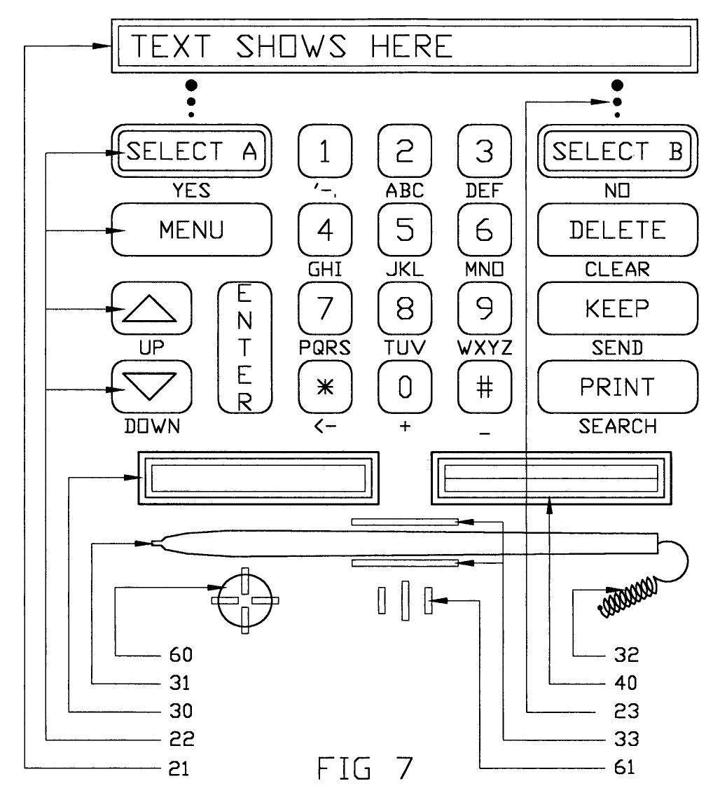

FIG. 7 shows a typical input/output (I/O) center 20, including a visual display 21, keypad 22, decals 23, scanner 30, light pen 31, cord 32, holding clip 33, printer 40, speaker 60, and microphone 61.

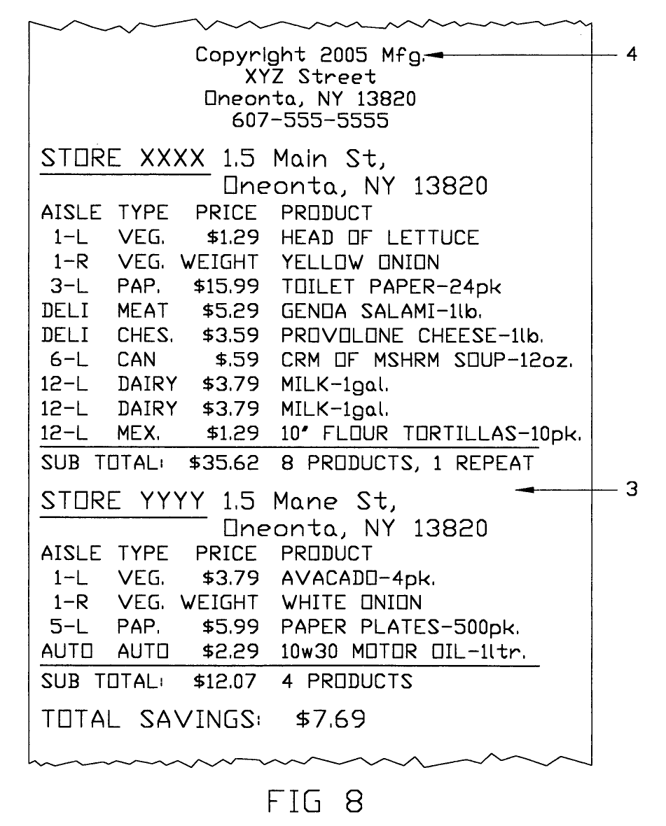

FIG. 8 shows an example of printed output from the device 1. This shopping list 3 shows the items sorted first by store, then by aisle, then by type. The price is given also, but was previously used to determine which store list to place the item on. The list also shows a total savings to the user generated by the cost comparison activities of the device 1 (not shown in this drawing). Further, contact information and a copyright notification 4 are shown. Also, the total number of products and number of repeated products is also shown.

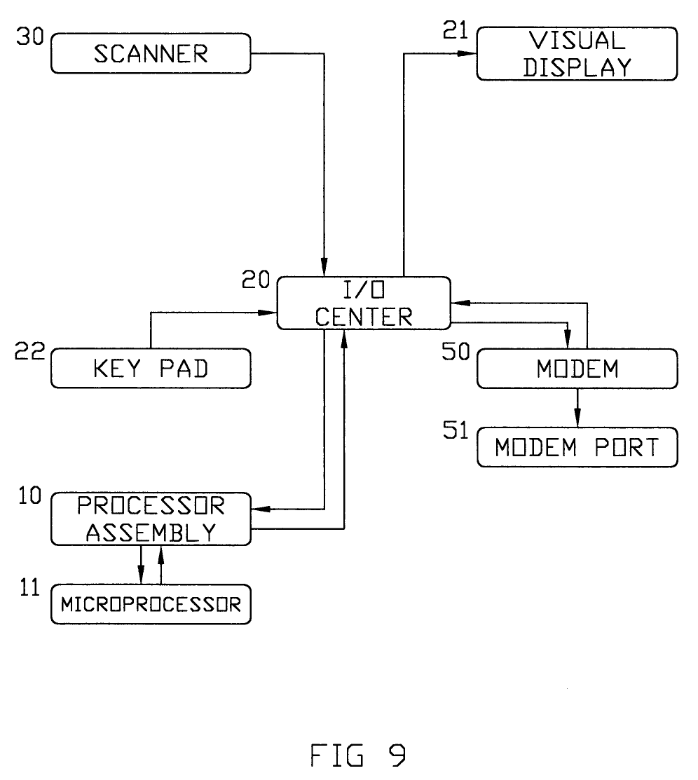

FIG. 9 shows a logistical display of a supplemental input device 2.

Note: a manufactured supplemental input device 2 may consist of a configuration somewhere between that of the configuration shown in FIG. 5 and FIG. 6 and that of the configuration shown in FIG. 9. Additionally, some other elements may be substituted for the elements shown in FIG. 9 for example: a keyboard might be substituted for the key pad 22.

The device 1 of the present invention generally includes a processor assembly 10, an input/output (I/O) center 20, a scanning mechanism typically a scanner 30, a printer 40 and a communication device typically a modem 50, which are integrated into the device 1. The processor assembly 10 generally comprises a microprocessor 11 which will be programmed to perform the functions described herein.

The I/O center 20, as shown in FIG. 7, generally comprises a visual display 21, a keypad 22 and a light pen 31. Additional elements can be added to this general configuration as described herein.

The visual display 21 which is preferably one or two lines of LED text characters similar to the type commonly used with typical calculators. The visual display 21 displays text which prompts the user and also provides output requested by the user. Alternatively, the visual display 21 could be a touch screen display. In this case, the keypad 22 may not be required.

The printer 40 is a simple small printer of the type often used with printing calculators which allows the user to print shopping list 3.

The keypad 22 allows the user to input information into the device 1. The keypad 22 can be provided in various configurations including keys with alpha-numeric characters similar to a commonly used telephone pad, and command keys similar to a commonly used microwave. The keypad 22 is preferably fixed in the device. Alternatively, the keypad 22 can be connected to the device 1 through a cord (not shown) or can be provided with remote access capabilities similar to a television remote control.

The scanner 30 is preferably connected to the device 1 internally. The scanner 30 is preferably used to read UPC bar codes, EAN codes, JAN codes, PDF 417 or other symbols used in the labeling of consumer goods. Alternatively, a light pen 31 could be connected to the device 1 through a cord 32. Holding clip 33 is provided to hold the light pen 31. The light pen 31 is alternatively used to read UPC bar codes or other symbols used in the labeling of consumer goods. In this case, the scanner 30 may not be required.

The device 1 is normally powered by a power source 80 consisting of an electrical plug 81 or the host appliance. It is additionally preferred that a back-up battery 82 be supplied to maintain data during power interruptions.

As shown in FIG. 7, the visual display 21 shows text messages including the date, time and current quantity of items on the list. The keypad 22 allows the user to select various options. These function selection techniques will be familiar to individuals who have used household appliances.

It is contemplated that the principal means of entering data about the consumer goods will be the use of the UPC bar code and other similar symbols. This data will generally be entered by moving the bar code in front of the scanner 30 or sliding the light pen 31 across the bar code. Alternatively, the product number may be entered into the device via the keypad 22. In most instances, the UPC or other codes will correlate to information about the product contained in the microprocessor 11 or a remote database accessed via the modem 50.

In the instance where a UPC or other code is not recognized by the device, the user will be prompted to instruct the device to ‘look up’ the item in databases maintained by the manufacturer of device 1 or one or more retail stores, via the modem 50 or to enter text for the product to then be stored, within the microprocessor 11, with the unrecognized bar code. This data may be entered by the user through the keypad 22 as text (example: “onion soup”) in a fashion similar to entering text into a cell phone. In the instance where a UPC or other code is not provided, or it has been discarded or lost, the data may be entered by the user through the keypad 22 as text (example: “lettuce”).

When an item is entered via UPC or other code or text the microprocessor will check the current list for duplicates and then add the product to the shopping list. Each time a product is found by the system to be ‘already on the list’ the user will be prompted to confirm the duplication of that product on the list.

The processor assembly 10 with microprocessor 11 is preferably about the size of a hand held calculator. The microprocessor 11 will have sufficient memory capacity to store hundreds of thousands of product records. Each product record may include, but is not limited to, the UPC or other codes, item name, brand name, purchase date, price, a store code and aisle number. The processor assembly 10 with microprocessor 11 is also able to be programmed with the decoding logic necessary for reading UPC symbol codes and other similar symbols.

As can be seen from the above description, the present device will provide a user with a readily available means of adding an item to a shopping list 3 (presumably just before discarding the item or its packaging) at a convenient location (the refrigerator, freezer or near the trash can or telephone). For instance, the user may input items to the list as those items are discarded. Also, when a purchased item is unwrapped before it is normally used (example: a secondary overwrap), the wrapper can be scanned and discarded before the product is actually used.

To find out the items on the shopping list 3, the user simply hits the up or down arrow keys on the keypad 22 to scroll through the list. To print the shopping list 3 the user hits print. Many other assorted features may apply.

The modem 50 may be used to send a text version of the shopping list 3 to a computer, cell phone, personal digital assistant, global positioning device or other electronic device capable of receiving and displaying electronic data. Additionally, the user could call the present invention via the modem 50 to download the shopping list 3 to their cell phone in the event that they forgot to print the shopping list 3. The modem 50 may alternatively be replaced with or supplemented by an inferred data transmitter/receiver 73, a remote control 74, a wireless network transmitter 70, a satellite link 71 or other transmission device.

The modem 50 will also be used to download store specific information into the microprocessor 11. This information can consist of a store number and aisle number associated with that specific store and pricing information. Additionally, the modem 50 could be used to contact two or more stores in the area to obtain pricing and aisle location information. The microprocessor 11 can then sort the item information by store name and price, creating two or more separate shopping lists 3, one list for each store, placing the items on the list for the store having the lowest price. This feature can save the consumer thousands of dollars per year.

Similarly, the device 1 could be configured in a more advanced version to comparison shop a product between multiple different brands of the same type of item, having different UPS codes, allowing the consumer to shop by store price comparison of the exact item and manufacturer brand price comparison between different brands of the same type of item.

The microprocessor 11 can sort the products on the list by several other criteria. For example, a user could sort by aisle number or food category and print the shopping list 3 in that order to speed the selection of items in the store, or to help find a specific item in the store when the user is unsure of it's likely location. This is generally done automatically as shown in FIG. 8.

The device could also maintain a list of continually purchased items as selected by the user. These items would no longer need to be scanned, and would always appear on the shopping list and be sorted by store, price and other criteria. For example, regular staples such as milk, eggs, cheese, bread, toilet paper, etc. could be left on the list indefinitely.

As shown in FIG. 9, a supplemental input device 2 may be connected to the device 1 via the input/output port 52. A supplemental input device 2 would likely include a scanner 30, visual display 21 and keypad 22. The supplemental input device 2 could be located in another room (bathroom, pantry, garage, bedroom, etc.) and feed user data entry back to the primary device 1 where shopping list creation and printing/transmitting occur. A residence could have any number of supplemental input devices 2.

The device 1 has inherent usefulness to disabled persons who are unable to write, and may simply scan the item into the system and print when ready to shop. Furthermore, the device could be configured in several forms to aid the disabled. The microphone 61 could be used in conjunction with voice recognition software to input data by a disabled person unable to use the scanner or keypad. Further, a visually impaired person may have the device 1 read the data and commands via text reading software and the speaker 60. Brail signage 24 (not shown) can be implemented on the key pad 22 to complete this process. Additionally the device 1 could by linked to a TDI Device for further handicapped assistance.

In addition to maintaining a shopping list 3, incorporation of the present invention into an appliance surface 90, or telephone 93 may permit the user to control some or all of the appliance or telephone features directly from the device 1, or to control the device 1 from the appliance or telephone controls. In many instances, it may be best to integrate the controls of the device I into the design and construction of the controls for appliance or telephone.

In addition to maintaining a shopping list 3, the device can incorporate the features of a typical printing calculator and be used as such.

In addition to maintaining a shopping list 3, the device could incorporate the features of a typical telephone via use of the microphone 61, speaker 60 and modem 50 and be used as such.

In addition to maintaining a shopping list 3, the device could incorporate the features of a recording device via use of the microphone 61, speaker 60 and modem 50 and be used for voice mail, audio reminders or the like.

In addition to the above, the device 1 can be used in a small business setting. Each employee can scan items as described herein. In this configuration, there would be a user code used by each employee or user, used to indicate what employee or user scanned the item, and a password to verify the identity of that employee or user. Multiple distinct shopping lists could then be created for each employee or user. The purchasing agent for the business could then assemble the shopping lists for comparison inquiry to the stores and finally review and purchase the needed items. Multiple distinct user lists could be used in the home setting as well, for example, college roommates with separate shopping lists.

The device 1 can convey to the store or stores the shopping list 3 for the purpose of inventory control and marketing research. When the price comparison inquiry is done via the modem 50 to the retailer database, the retailer is advised of the user's intent to buy the given items in the near future. At this time the items on the previous shopping list are removed from the store's imminent demand list and the new items are added. The Retailer's software can then check the current inventory, subtract the total quantity of items inquired about (by multiple users of the device 1), and warn the retailer's purchasing department of pending shortages in inventory. Example: There are 91 inquiries into the price of item ZZZ over the last three days, store WWW has the best price, but only 43 of item ZZZ in stock, the retailer can order and receive more of item ZZZ before the imminent demand for item ZZZ exhausts the inventory and as a result the retailer looses out on up to 48 sales of item ZZZ.

Additionally, the marketing data can allow the store to improve turnover of products. The inquiries data can help determine if an item has an excess inventory. In this event, excess inventory items can have the shelf space allocated to those items reduced to a level where it maintains imminent demand plus a margin, but does not over exceed ‘actual demand’ by occupying more shelf space than that necessary to meet the imminent demand plus a margin. This allows more shelf space for other items or for items with greater imminent demand that usually go out of stock because the imminent demand was underestimated by the retailer's purchasing department. This is useful since retailers may not be able to track this type of lost sale since the consumer will either select a second favorite item instead, or purchase the desired item at another store.

The device 1 can further provide better communication between the retailer and the consumer as a direct line of communication exists because of the device 1. The communication process defined herewith would allow the retailer to conduct marketing research by sending questions, polls or quarries to the consumer directly via the device 1 and receiving the response directly in return.

Furthermore, the shopping list 3 can be forwarded in digital form to a fulfillment house for direct delivery or to a web site for remote downloading (perhaps just before leaving work and going to the store).

What is claim is:

1. A free standing, hand held, surface mountable or inset device used for creating a shopping list of needed products incorporating a scanning system, a display system, an input/output center, a printer and a communications device comprising:
a) a microprocessor including memory that stores the user entered information about consumer goods and reference database information provided by the manufacturer of the device and/or one or more stores;
b) a means associated with the microprocessor for inputting information regarding consumer goods;
c) a means associated with the microprocessor for transmitting and receiving information regarding consumer goods from the manufacturer of the device and/or one or more stores including, but not limited to, the product name, brand name, retail price, store, store location and brand name comparison information;
d) a display means for reviewing, editing and sorting the stored information about consumer goods in a human readable form;
e) an output means for transmitting, printing or conveying the data in various forms predominately that of a shopping list;
f) a means for sorting the information regarding consumer goods by price (comparison shopping) and by retail store or stores, then further sorting the information regarding consumer goods by location within the store or stores.

2. The device of claim 1 wherein the means for inputting information includes a keypad, keyboard, remote control, microphone and speech recognition software, inferred transmitter, or other I/O device or devices.

3. The device of claim 1 wherein the scanning device is a scanner, wand, light pen, bar code scanner, or any optical recognition technology other I/O device or devices.

4. The device of claim 1 wherein the communications device consists of a modem, USB, firewire, wireless network, transmitter, telephone or other communications system for use in transmitting the information about the consumer goods in a computer readable format or a human readable format (i.e. text file) to a computer, cell phone, personal digital assistant, global positioning device or other electronic device capable of receiving and displaying the electronic data.

5. The device of claim 1 wherein the means for transmitting the shopping list is used to contact one or more stores for the purpose of receiving product information, do price comparisons and, in return, providing data to the store for use in inventory maintenance and marketing.

6. The device of claim 1 wherein the means of transmitting information regarding consumer goods is used to contact one or more stores for the purpose of purchasing the consumer goods and receiving direct fulfillment services by the store or stores.

7. The device of claim 1 wherein a handicapped or disable user can use the device by alternative means including, but not limited to, a combination of the following: brail symbols, microphone, voice recognition software, TDD Device and text to speech software.

8. The device of claim 1 wherein the device can detect when the device is out of paper or ink and advise the user or automatically process a refill order for the paper and/or the ink.

9. The device of claim 1 whereby the consumer is a purchasing agent for a business and a user code and password feature will allow multiple separate lists for multiple separate users (i.e. employees) and link those lists to a single master user and/or purchasing agent.

10. A free standing, hand held, surface mountable or inset device used for creating a shopping list of needed products incorporating a UPC scanner, an L.E.D. display, an input/output center, a printer and a communications device comprising:
a) a microprocessor including memory that stores the user entered information about consumer goods and reference database information provided by the manufacturer of the device and/or one or more stores;
b) a means associated with the microprocessor for inputting information regarding consumer goods;
c) a means associated with the microprocessor for transmitting and receiving information regarding consumer goods from the manufacturer of the device and/or one or more stores including, but not limited to, the product name, brand name, retail price, store, store location and brand name comparison information;
d) a display means for reviewing, editing and sorting the stored information about consumer goods in a human readable form;
e) an output means for transmitting, printing or conveying the data in various forms predominately that of a shopping list;
f) a means for sorting the information regarding consumer goods by price (comparison shopping) and by retail store or stores, then further sorting the information regarding consumer goods by location within the store or stores.

11. The device of claim 10 wherein the means for inputting information includes a keypad and/or microphone.

12. The device of claim 10 wherein the means for transmitting the shopping list is used to contact one or more stores for the purpose of receiving product information, do price comparisons and, in return, providing data to the store for use in inventory maintenance and marketing.

13. The device of claim 10 wherein the means of transmitting information regarding consumer goods is used to contact one or more stores for the purpose of purchasing the consumer goods and receiving direct fulfillment services by the store or stores.

14. The device of claim 10 wherein a handicapped or disable user can use the device by alternative means including, but not limited to, a combination of the following: brail symbols, microphone, voice recognition software, TDD Device and text to speech software.

15. The device of claims 10 wherein the consumer is a purchasing agent for a business and a user code and password will allow multiple separate lists for multiple separate users (employees) and link those lists to a single master user and/or purchasing agent.

16. The device of claim 1 wherein one or more supplemental devices may communicate with the device of claim 1, whereby said supplemental device would typically consist of A free standing, hand held, surface mountable or inset device used for collecting data for the device of claim 1, incorporating a scanning system, a display system, an input/output center and a communications device comprising:
a) a microprocessor including memory that stores the user entered information about consumer goods and transmits that information to the device of claim 1;
b) a means associated with the microprocessor for inputting information regarding consumer goods;
c) a display means for reviewing and editing the information in a human readable form prior to transmitting the information to the device of claim 1.

17. The device of claim 10 wherein one or more supplemental devices may communicate with the device of claim 10, whereby said supplemental device would typically consist of A free standing, hand held, surface mountable or inset device used for collecting data for the device of claim 10, incorporating a scanning system, a display system, an input/output center and a communications device comprising:
a) a microprocessor including memory that stores the user entered information about consumer goods and transmits that information to the device of claim 10;
b) a means associated with the microprocessor for inputting information regarding consumer goods;
c) a display means for reviewing and editing the information in a human readable form prior to transmitting the information to the device of claim 10.

18. The Device of claim 1 whereby the method of retail marketing research, product promotion, inventory control, inventory adjustment and/or payment processing, by a retail store, discount store, online store or wholesaler consists of one or more of the following as provided by the functions of the device of claim 1:
a) the imminent demand for the retailer's products as determined by the transmission of product data from the consumer to the retailer in the form of a list of the products the user intends to buy in the near future (also known as a shopping list);
b) marketing information is received by the retailer from the consumer in the form of an answer or answers to marketing questions, polls or quarries;
c) promotional materials can be transmitted to the consumer based on the information found in the consumer's transmitted shopping list;
d) payment information and method for possible fulfillment purposes of the shopping list.

19. The Device of claim 10 whereby the method of retail marketing research, product promotion, inventory control, inventory adjustment and/or payment processing, by a retail store, discount store, online store or wholesaler consists of one or more of the following as provided by the functions of the device of claim 10:
a) the imminent demand for the retailer's products as determined by the transmission of product data from the consumer to the retailer in the form of a list of the products the user intends to buy in the near future (also known as a shopping list);
b) marketing information is received by the retailer from the consumer in the form of an answer or answers to marketing questions, polls or quarries;
c) promotional materials can be transmitted to the consumer based on the information found in the consumer's transmitted shopping list;
d) payment information and method for possible fulfillment purposes of the shopping list.
